(19) United States
(12) Patent Application Publication
(10) Pub. No.: US 2024/0303498 A1
(43) Pub. Date: Sep. 12, 2024

(54) Coordinating Reinforcement Learning (RL) for multiple agents in a distributed system

(71) Applicant: Ciena Corporation, Hanover, MD (US)

(72) Inventors: Emil Janulewicz, Ottawa (CA); Sergio Slobodrian, Richmond (CA)

(21) Appl. No.: 18/119,755

(22) Filed: Mar. 9, 2023

(51) Int. Cl. G06N 3/092; G06N 3/098

(52) U.S. Cl. CPC G06N 3/092; G06N 3/098

(57) ABSTRACT

Systems and methods are provided for training Reinforcement Learning (RL) policies for a number of agents distributed throughout a network. According to one implementation, a method associated with an individual agent includes participating in a training process involving each of the multiple agents, the training process including multiple rounds of training allowing each agent to perform a local improvement procedure using RL. During each round of training, the method also includes performing the local improvement procedure using training data associated with one or more other agents having a relatively high level of affiliation of different levels of affiliation with the individual agent and additional training data associated with the individual agent itself. According to additional embodiments, a controller may coordinate the local improvement procedures. During inference, the RL policies can be used without the help of the controller.

### TECHNICAL FIELD

The present disclosure generally relates to Artificial Intelligence (AI) and Reinforcement Learning (RL). More particularly, the present disclosure relates to the coordination of RL policy training and inference for multiple agents or nodes in a distributed system or communications network.

### BACKGROUND

In communications networks, certain AI and RL policies may be attained to optimize the networks. For example, some integer linear optimization policies and mixed integer linear optimization policies may be developed to find optimal network resource allocation. The AI policies may use supervised learning. However, these policies typically involve a central controller that has visibility of the entire network. A problem with this type of arrangement is that the central controller can become overwhelmed as the network grows.

In some cases, RL may be used in a distributed manner, where each node is employed to train a policy. The RL training in this case requires that each agent or node works to train towards the same model, which may use a type of parallel training technique. However, there are also many problems with this arrangement as well. For example, weights are normally shared, which does not account for differences throughout the network. Also, the state space (or observational space) includes the entire fabric, which can be complex, especially as the network grows.

Heuristics in this regards may be based on searches. Also, for handling issues such as network surges, many policies for the network may be over-engineered in certain areas of the network, while leaving other areas under-represented. The conventional systems and methods for creating optimal network solutions often do not scale well and are far too complex for real world networks. In fact, many solutions for optimization are infeasible, other than for extremely small environments. Also, these conventional solutions often used a centralized approach, as mentioned above, which requires state of the art hardware (e.g., graphical processing units) and other high costs for computation. In addition, even if a network were to be optimized using the complex training methods of the conventional system, it is likely that there is an extensive amount of time needed to arrive at a reasonable solution. Also, it is likely that, once such a solution is attained, the network may have already been updated and a new policy would need to be retrained. Therefore, there is a need in the field of AI and RL to overcome these issues of the conventional systems.

### BRIEF SUMMARY

The present disclosure is directed to systems and methods for coordinating multiple agents or nodes in a distributed system or network to allow them to perform Reinforcement Training (RL) procedures to improve an RL reward locally. Each agent is given a turn during each of multiple training rounds to perform the local “optimization,” which actually may not necessarily be an optimization per se, but instead may represent a slight improvement over a current state. Then, over several rounds where each of the multiple agents can participate to optimize their local rewards, a global RL policy emerges that provides better handling of environmental states. In one particular example, an RL policy may be configured to optimize the allocation of network service requests among nodes (represented by agents) to maximize resource utilization to thereby maximize the number of network service requests that can be completed, which of course can thereby maximize revenue for a service provider.

A first implementation is associated with individual agent, a node, or other suitable element that may include a non-transitory computer-readable medium and/or various methods and processes. The individual agent may be arranged within a distributed system having multiple agents and multiple links, wherein the multiple agents and multiple links are arranged in such a way so as to create different levels of affiliations between the agents. One process may include participating in a training process involving each of the multiple agents. The training process includes multiple rounds of training, where each round of training allows each agent to perform a local improvement procedure using RL. During each round of training, the process also includes performing the local improvement procedure using training data associated with one or more other agents having a relatively high level of affiliation with the individual agent and additional training data associated with the individual agent itself. The training data associated with each agent includes at least a local RL policy under development.

According to some embodiments of this agent-based process, the individual agent has little or no visibility of another set of one or more other agents having a relatively low level of affiliation with the individual agent. Also, the local improvement procedure may be configured to increase an RL reward of the respective local RL policy under development. In each round, the local improvement procedure may be configured to increase the RL reward up to a certain degree.

Furthermore, after each round of training is complete, a global reward value may be calculated from the local RL policies under development associated with each of the multiple agents. The global reward value may be related to an optimization of the entire distributed system. In each round, the training process may allow one agent at a time to perform its respective local improvement procedure in accordance with a predetermined sequence until each agent has had a turn to complete it. It may be noted that the distributed system may be one of a real-world system, a virtual system, and a simulated system.

The distributed system used in this agent-based process may be a communications network, where each agent is associated with a network node, the individual agent is associated with an individual network node, and each link is associated with a communication path between nodes. As such, the training data may be associated with each agent includes resource availability information related to an ability to perform network service functions, and the training data can also include a sequential flow of network requests. The local RL policy of the individual agent may be combined with the local RL policies of the other agents to create a global RL policy for maximizing utilization of the network nodes to handle as many network service requests as possible. After completing the multiple rounds of training of the training process, each network node may be configured to utilize a network service distribution technique, in accordance with the global RL policy, to perform actions intended to meet one or more network service requests or one or more portions of network service requests and to pass one or more network service requests or one or more portions of network service request to one or more adjacent network nodes. Each of the one or more adjacent network nodes may be represented by an agent having a relatively high level of affiliation with the individual agent associated with the individual network node.

According to another implementation, the present disclosure also provides a process, method, and/or non-transitory computer-readable medium configured to store computer logic having instructions that enables one or more processing devices to perform a method or process associated with a coordinator. The coordinator, in this respect, may be configured to coordinate a training process for training a distributed system having multiple agents and multiple links, where the multiple agents and multiple links are arranged in such a way so as to create different levels of affiliations between the agents. The coordinator-based process may also include prompting each agent, within a training round, to perform a local improvement procedure using RL, where the local improvement procedure allows each individual agent to use training data associated with one or more other agents having a relatively high level of affiliation with the individual agent and additional training data associated with the individual agent itself. The training data associated with each agent may include at least a local RL policy under development. Also, the coordinator-based method may include enabling the multiple agents to repeat multiple training rounds.

In yet another implementation, the present disclosure provides methods, processes, and non-transitory computer-readable medium for performing inference once the system has been trained. The process in this respect may also be associated with an individual node arranged within a distributed system having multiple nodes and multiple links arranged in such a way so as to create different levels of affiliations between the nodes. The method, process, and/or non-transitory computer-readable medium may be configured to store computer logic having instructions that, when executed, enable one or more processing devices to perform inference. For example, the inference steps may include implementing, during an inference stage, a network service distribution technique in accordance with a global RL policy associated with the distributed system. The global RL policy may be attained during a training stage in which each node attains a local RL policy. In response to the distributed system receiving network service requests, the network service distribution technique instructs the individual node to perform actions to satisfy at least a portion of one or more of the network service requests and to pass unsatisfied portions of the network service requests to one or more nodes having a relatively high level of affiliation with the individual node.

### BRIEF DESCRIPTION OF THE DRAWINGS

The present disclosure is illustrated and described herein with reference to the various drawings. Like reference numbers are used to denote like components/steps, as appropriate. Unless otherwise noted, components depicted in the drawings are not necessarily drawn to scale.

FIG. 1 is a diagram illustrating an example of a distributed system in which a Reinforcement Learning (RL) policy is to be attained, according to various embodiments.

FIG. 2 is a block diagram illustrating the coordinator shown in FIG. 1 for coordinating a training process for the nodes of the distributed system of FIG. 1, according to various embodiments.

FIG. 3 is a block diagram illustrating one of the nodes shown in FIG. 1, according to various embodiments.

FIG. 4 is a block diagram illustrating a self-optimizing framework, according to various embodiments.

FIG. 5 is a block diagram illustrating a RL feedback loop, according to various embodiments.

FIG. 6 is a diagram illustrating an algorithm for performing a multi-agent training loop, according to various embodiments.

FIG. 7 is a graph illustrating an average reward per training round during an RL training process, according to various embodiments.

FIG. 8 is a table illustrating reward values resulting at the end of each round of training, according to various embodiments.

FIG. 9 is a flow diagram illustrating a sequence of callbacks initiated during every round of a training process, according to various embodiments.

FIG. 10 is a block diagram illustrating a system for training multiple agents in a distributed system, according to various embodiments.

FIG. 11 is a block diagram illustrating a RL policy for allocating network resources in a distributed network, according to various embodiments.

FIG. 12 is a block diagram illustrating a system for training a stable-baseline model in a distributed system, according to various embodiments.

FIG. 13 is a graph illustrating the capabilities of the RL models and policies of the present disclosure compared to conventional models.

FIG. 14 is a flow diagram illustrating a process for training an individual agent of a distributed system, according to various embodiments.

FIG. 15 is a flow diagram illustrating a process for coordinating a training procedure for a distributed system, according to various embodiments.

FIG. 16 is a flow diagram illustrating a process for implementing a global RL policy, according to various embodiments.

### DETAILED DESCRIPTION

The present disclosure relates to systems and methods for performing various Artificial Intelligence (AI) or Reinforcement Learning (RL) techniques. The AI and RL techniques, in particular, include a first (training) stage related to training an RL policy (e.g., a policy for optimizing performance of a system) and a second (inference) stage related to implementing the trained RL policy. For example, some RL policies that may be trained and implemented, according to the present disclosure, may include techniques for defining how a communications network behaves. Network behavior may be defined by how data traffic is routed through the network, how network resources are optimized, etc.

It may be noted that many examples described in the present disclosure are related to scenarios in which the environment being trained is a communications network having multiple nodes, communication links, and other network equipment for enabling the transmission of data packets throughout the network. It should be noted, however, that the systems and methods of the present disclosure may also be directed toward other types of distributed systems in which multiple agents are arranged such that each agent may have any level of affiliation with the other agents.

In particular, to overcome some of the issues with conventional RL systems, the embodiments of the present disclosure are configured to use a “distributed” approach in which each node or agent in a distributed system is capable of performing a “local” optimization (or improvement) procedure. Each agent is configured to perform this local optimization during each round of a training process. In some embodiments, the training process may be coordinated or orchestrated by a coordinator that operates in a control plane or external to operational realm of the distributed system. In other embodiments, the training process may be a “decentralized” process, whereby the nodes have the capability of sending messages amongst themselves to enable some type of coordination or order during the training phase. For example, the decentralized process may then be performed without the use of a coordinator or central controller.

By delegating optimization efforts to each agent (e.g., node), the complexity is maintained at a low level and does not interrupt a complex training process that might be performed on the entire system by a central controller. Thus, even when nodes or agents are added to or removed from the distributed system, only a handful of other existing nodes or agents might be affected by the change and thereby retraining is expected to involve only minimal efforts. The decentralized and distributed approaches, with respect to RL training and inference, are configured to reduce the complexity in the environment state required for each agent. Also, this reduces the hardware requirements and energy consumption and can be applied practically for large fabrics or network topologies. In addition, by maximizing fabric utilization, networks can have lean operation and reduce operating expenses.

There has thus been outlined, rather broadly, the features of the present disclosure in order that the detailed description may be better understood, and in order that the present contribution to the art may be better appreciated. There are additional features of the various embodiments that will be described herein. It is to be understood that the present disclosure is not limited to the details of construction and to the arrangements of the components set forth in the following description or illustrated in the drawings. Rather, the embodiments of the present disclosure may be capable of other implementations and configurations and may be practiced or carried out in various ways. Also, it is to be understood that the phraseology and terminology employed are for the purpose of description and should not be regarded as limiting.

As such, those skilled in the art will appreciate that the inventive conception, upon which this disclosure is based, may readily be utilized as a basis for the designing of other structures, methods, and systems for carrying out the several purposes described in the present disclosure. Those skilled in the art will understand that the embodiments may include various equivalent constructions insofar as they do not depart from the spirit and scope of the present invention. Additional aspects and advantages of the present disclosure will be apparent from the following detailed description of exemplary embodiments which are illustrated in the accompanying drawings.

### Distributed System

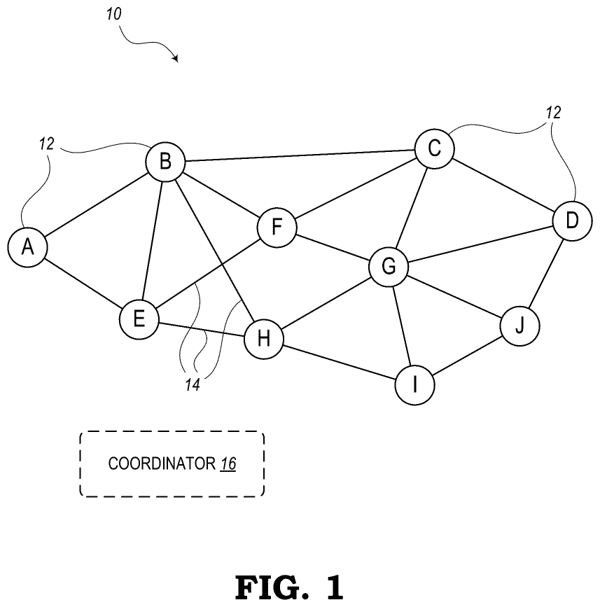

FIG. 1 is a diagram illustrating an embodiment of a distributed system 10. As shown, the distributed system 10 includes a “fabric” that includes a plurality of agents 12 (e.g., RL agents). Also, the distributed system 10 includes a plurality of links 14, each of which is configured to physically, logically, or virtually connect a pair of adjacent agents 12. The agents 12 and links 14 may be arranged in the distributed system 10 according to any suitable architecture or topology. A fabric, according to the present disclosure, may refer to the combination of agents 12 and links 14 as well as relevant functionality (e.g., Virtual Network Functions (VNFs), etc.) in a system or network.

It may be noted that some agents 12 are arranged farther away from others. That is, in a network environment, transmitting data packets from one agent 12 (e.g., node) to another may take several “hops.” Some pairs of adjacent agents 12 (i.e., those connected by a single link 14 or one-hop pairs) can be considered to have a relatively high degree of affiliation with each other, whereby pairs separated farther from each other (e.g., multi-hop) may be considered to have a relatively low degree of affiliation. It should also be noted that the distributed system 10 can have a changeable architecture as a result of one or more agents 12 or links 14 being added to or removed from the distributed system 10.

According to various embodiments, the distributed system 10 may be a communications network, a network domain, an autonomous system, an enterprise system, a mesh-type network, or other various types of systems having any type of topology or fabric, including fabrics with a greater complexity and size than the example shown in FIG. 1. With respect to embodiments in which the distributed system 10 is a communications network, for example, the agents 12 may be nodes (e.g., network elements, switches, routers, etc.) and the links 14 may be connectors, optical fibers, Ethernet cables, etc. In this scenario, each node may include a respective agent 12 that is configured to perform certain functionality, such as packet routing tasks, network service provisioning, etc.

In some embodiments, the distributed system 10 may include or may be in communication with a coordinator 16. The coordinator 16, for example, may be configured to operate in a control plane, for example, and may be configured to operate as a control device for controlling certain aspects of the agents 12, links 14, VNFs, etc. In the present disclosure, the coordinator 16 may be configured to organize or coordinate the agents 12 to assist with self-optimization operations in order to achieve an optimal global result for the entire distributed system 10. For example, according to some embodiments, when the distributed system 10 is configured as a communications network, the coordinator 16 may be configured to optimize the utilization of each node and its resources (e.g., processing capabilities, storage capabilities, etc.) with respect to network services.

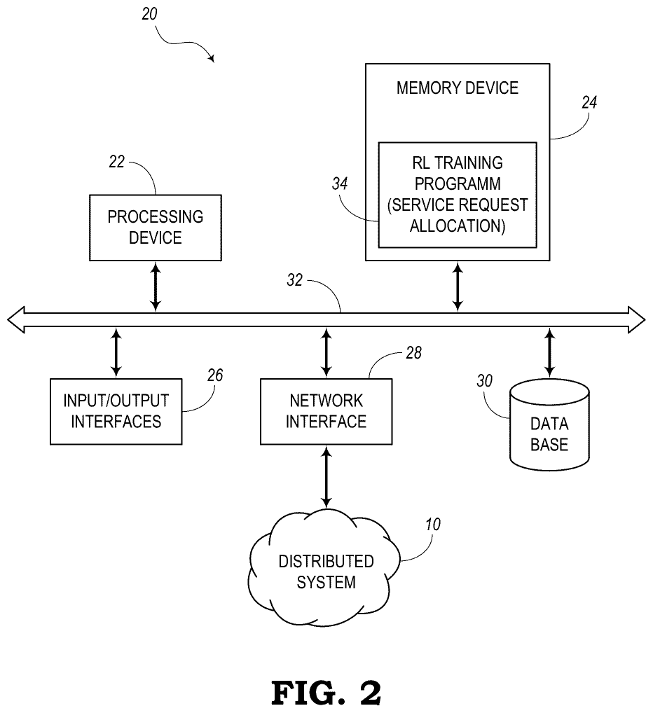

According to some embodiments, the distributed system 10 may operate without the use of the coordinator 16. In this respect, the coordinator 16 may be omitted. As such, the agents 12 themselves may be configured to perform any type of coordination efforts that might be normally associated with the coordinator 16 as described below with respect to FIG. 2. For example, without the coordinator 16, the agents 12 may be configured to communicate with each other to arrange a training sequence that defines which agent is supposed to perform a self-optimization process during each round of training. Also, the agents 12 may be configured to gather the results of the individual or local optimization efforts to determine when to move on to the next agent and when to move on to the next training round. Furthermore, the agents 12 may also create a global optimization result, which may include instructions about how each agent 12 is supposed to operate to satisfy some criteria or request.

### Coordinator

FIG. 2 is a block diagram illustrating an embodiment of the coordinator 16 shown in FIG. 1 for coordinating a training process for the agents 12 of the distributed system 10. In the illustrated embodiment, the coordinator 16 may be a digital computing device that generally includes a processing device 22, a memory device 24, Input/Output (I/O) interfaces 26, a network interface 28, and a database 30. It should be appreciated that FIG. 2 depicts the coordinator 16 in a simplified manner, where some embodiments may include additional components and suitably configured processing logic to support known or conventional operating features. The components (i.e., 22, 24, 26, 28, 30) may be communicatively coupled via a local interface 32. The local interface 32 may include, for example, one or more buses or other wired or wireless connections. The local interface 32 may also include controllers, buffers, caches, drivers, repeaters, receivers, among other elements, to enable communication. Further, the local interface 32 may include address, control, and/or data connections to enable appropriate communications among the components 22, 24, 26, 28, 30.

The coordinator 16 may also include a service request allocation program 34, which may be implemented in any suitable combination of software or firmware in the memory device 24 and/or hardware in the processing device 22. The service request allocation program 34 may be configured in non-transitory computer-readable media and may be executed by the processing device 22. The service request allocation program 34 may include computer logic having instructions that enable or cause the processing device 22 to perform certain functions to coordinate local optimization procedures at each agent 12, which may include providing a sequence or order to processing that the agents 12 follow. Each agent 12 may be configured to perform the local optimization during each training round. The coordinator 16 may allow the training process to continue for any number of rounds as needed.

### Each Agent/Node

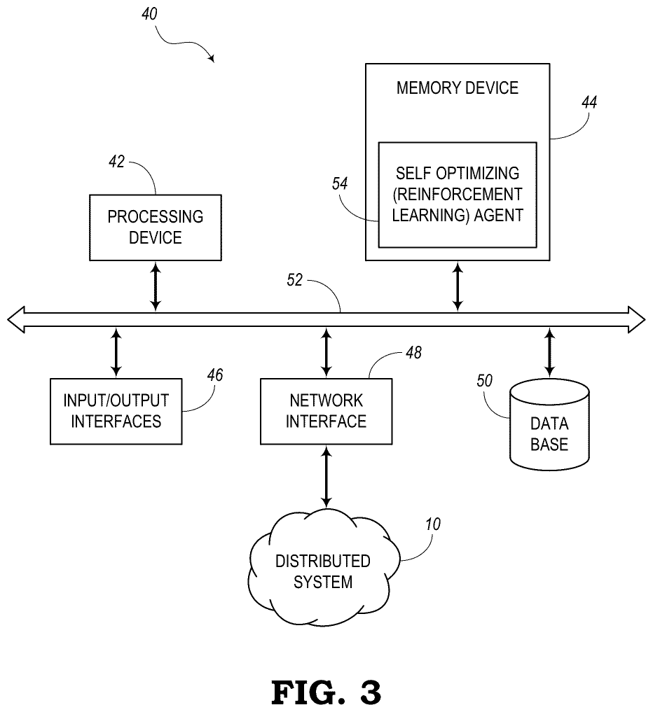

FIG. 3 is a block diagram illustrating an embodiment of a node 40 of a distributed system. In some embodiments, the node 40 may represent one or more of the agents 12 shown in FIG. 1 and/or may include the agent 12. In the illustrated embodiment, the node 40 may be a digital computing device that generally includes a processing device 42, a memory device 44, I/O interfaces 46, a network interface 48, and a database 50. It should be appreciated that FIG. 3 depicts the node 40 in a simplified manner, where some embodiments may include additional components and suitably configured processing logic to support known or conventional operating features. The components (i.e., 42, 44, 46, 48, 50) may be communicatively coupled via a local interface 52. The local interface 52 may include, for example, one or more buses or other wired or wireless connections. The local interface 52 may also include controllers, buffers, caches, drivers, repeaters, receivers, among other elements, to enable communication. Further, the local interface 52 may include address, control, and/or data connections to enable appropriate communications among the components 42, 44, 46, 48, 50.

The node 40 may include a self-optimizing agent 54, which may be implemented in any suitable combination of software or firmware in the memory device 44 and/or hardware in the processing device 42. The self-optimizing agent 34 may be configured in non-transitory computer-readable media and may be executed by the processing device 42. The self-optimizing agent 34 may include computer logic having instructions that enable or cause the processing device 22 to perform certain functions to determine a local optimization using training data of the node 40 itself as well as training data of one or more adjacent nodes 40 or other nodes or agents having a relatively high level of affiliation with the node 40. Results of the self-optimization may be shared with the coordinator 16 (when present in the distributed system 10) and/or with other nodes (when the coordinator 16 is not present in the distributed system 10). The combined results from each node or agent can then be combined to determine an RL policy for performing some task, such as optimizing network resource utility, minimizing traffic congestion, etc. The self-optimizing agent 54 may utilize RL or other AI or Machine Learning (ML) techniques. The self-optimizing agent 54 may be configured to operate, separate from operation of other agents in the distributed system, during each round of training. Also, the self-optimizing agent 54 may be run over multiple rounds to provide slight improvements over previous training runs.

The distributed system 10, coordinator 16, and node 40 (or agents) may each include various functionality for training and for inference with respect to RL policies. First of all, each node or agent is configured to perform certain actions, which may be included in the self-optimizing agent 54.

### Local Optimization Training

For example, the self-optimizing agent 54 may be associated with an individual agent arranged within a distributed system having multiple agents and multiple links. The multiple agents and multiple links are arranged in such a way so as to create different levels of affiliations among the agents. The self-optimizing agent 54 may store computer logic having instructions that, when executed, enable one or more processing devices (e.g., the processing device 42) to participate in a training process involving each of the multiple agents. The training process may include multiple rounds of training. Each round of training allows each agent to perform a local improvement procedure using RL. That is, it should be understood that “optimization” may actually include some measurable level of improvement toward to an optimal solution. Also, it should also be understood that an optimal solution may actually represent a solution that is a near to optimization as may be possible within a reasonable amount of time and with a limited number of resources.

During each round of training, the instructions of the self-optimizing agent 54 are further configured to enable the one or more processing devices (e.g., the processing device 42) to perform the local improvement procedure using training data associated with one or more other agents having a relatively high level of affiliation with the individual agent and additional training data associated with the individual agent itself. The training data associated with each agent is used to train a local RL policy under development.

Each local RL policy is considered to be “under development” since local optimization or improvement is performed individually without knowledge of what other nodes may have calculated during the training round. Also, according to some embodiments, the self-optimizing agent 54 may be configured to stop training at some point, such as when it is determine that a slight amount of progress has been made toward optimization. In this way, the one local optimization will not significantly alter optimization efforts of nearby agents, which may have already optimized during the training round or may optimize at a later time in the training round. Then, in the next round, additional progress can be made, and so on. The coordination of when nodes stop training in each round may be controlled by the coordinator 16.

### Coordinating the Training Rounds

In addition to the local improvement at each agent or node, another level of implementation includes the coordination of the various local policies under development. For example, this coordination may involve the coordinator 16. For example, the coordinator 16 (or the nodes themselves) may include functionality to coordinate the training process for training the distributed system 10 having the multiple agents 12 and multiple links 14. Again, the agents 12 and links 14 may be arranged in such a way so as to create different levels of affiliations between the agents 12. The coordination procedure may also include prompting each agent, within a training round, to perform a local improvement procedure using RL. The local improvement procedure allows each individual agent to use training data associated with one or more other agents having a relatively high level of affiliation with the individual agent and additional training data associated with the individual agent itself. The training data associated with each agent includes at least a local RL policy under development. Furthermore, the coordination procedure includes enabling the multiple agents 12 to repeat multiple training rounds.

In some embodiments, the individual agent may have little or no visibility of another one or more other agents having a relatively low level of affiliation with the individual agent (e.g., several hops away). The local improvement procedure may be configured to increase an RL reward of the respective local RL policy under development. In each round, the local improvement procedure may be configured to increase the RL reward up to a certain degree. Also, after each round of training is complete, a global reward value is calculated from the local RL policies under development associated with each of the multiple agents. The global reward value, for example, may be related to an optimization of the entire distributed system 10. In each round, the training process allows one agent at a time to perform its respective local improvement procedure in accordance with a predetermined sequence until each agent has completed its respective local improvement procedure.

Also, according to additional embodiments, the distributed system 10 described herein may be a real-world system, a virtual system, a simulated system, or other type of system. When the distributed system is configured as a communications network, for example, each agent 12 is associated with a network node, the individual agent is associated with an individual network node, and each link 14 is associated with a communication path between nodes. In some embodiments, the training data associated with each agent 12 may include resource availability information related to an ability to perform network service functions. In this respect, the local RL policy of the individual agent may be combined with the local RL policies of the other agents to provide a global RL policy for maximizing utilization of the network nodes to handle as many network service requests as possible. The global policy is a manifestation of the combination of individual local policies, i.e., there will never exist a single instance of a global policy somewhere in memory. After completing the multiple rounds of training of the training process, each network node may be configured to utilize a network service distribution technique, in accordance with the global RL policy, to perform actions intended to meet one or more network service requests or one or more portions of network service requests and to pass one or more network service requests or one or more portions of network service request to one or more adjacent network nodes, wherein each of the one or more adjacent network nodes is represented by an agent having a relatively high level of affiliation with the individual agent associated with the individual network node.

### Inference

Thirdly, after the local improvements and optimization rounds and the coordination of the global optimization training procedures, the trained RL policy can then be configured to run in a real-world environment, such as a communications network. This inference stage may involve using a combination of historic data as well as new real-world, real-time data that is obtained in the network (or distributed system 10). The RL policy may be stored in the memory device 44 of the individual node and may be configured unique for that node to instruct the node how to operate with the new data. The RL policy may be stored in non-transitory computer-readable medium (e.g., memory device 44, database 50, etc.) that is associated with the individual node. Still, the individual node will be arranged within the distributed system 10 having multiple nodes and multiple links, and again, the multiple nodes and multiple links are arranged in such a way so as to create different levels of affiliations between the nodes. The RL policy may include computer logic having instructions that, when executed, enable the processing device 42 to implement, during the inference stage, a network service distribution technique in accordance with a global Reinforcement Learning (RL) policy associated with the distributed system 10. The global RL policy may be attained during the training stage in which each node attains a local RL policy and the local policies are combined. In response to the distributed system 10 receiving network service requests, the network service distribution technique instructs the individual node to perform actions to satisfy at least a portion of one or more of the network service requests and to pass unsatisfied portions of the network service requests to one or more nodes having a relatively high level of affiliation with the individual node.

In some embodiments of the inference stage, the nodes having a relatively high level of affiliation with the individual node may be peer nodes arranged adjacent to the individual node in the distributed system 10. The prior training stage, as mentioned with respect to the first two stages, includes multiple rounds in which each node is configured to perform a local improvement procedure using RL to attain the respective local RL policy. The local improvement procedure uses training data associated with the one or more nodes having a relatively high level of affiliation with the individual node and additional training data associated with the individual node itself. The local RL policy of each node may be attained during the training stage as prompted by a coordinator arranged external to the distributed system. Also, the nodes may perform the network service distribution technique without the coordinator.

In some respect, the distributed system 10 may be considered to be a type of Self-Optimizing Fabric (SOF). Local optimization may be performed at the agent level and then a global view may be attained by combining the individual local views. In this way, the global view may be configured to maintain a level of optimal state, continuously adjusting to its internal and external demands, modifications, and events. Each agent 12 in the fabric participates in a self-optimizing function via a Sense, Discern, Infer, Decide, Act (SDIDA) framework.

### Self-Optimizing Framework

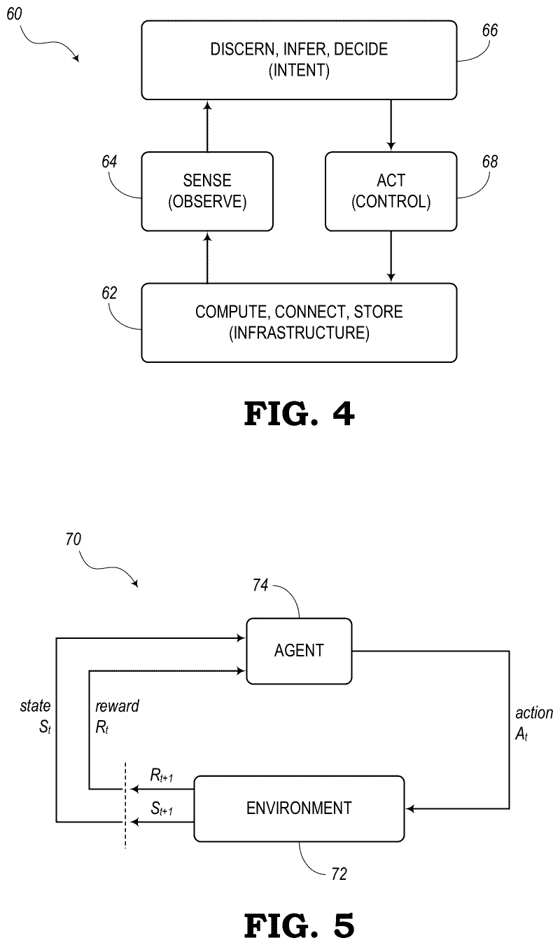

FIG. 4 is a block diagram illustrating an embodiment of a self-optimizing framework 60, which may be a SDIDA framework. The self-optimizing framework 60 includes a compute, connect, and store module 62, a sense module 64, a discern, infer, and decide module 66, and an act module 68. The sense module 62 may be part of an observation phase. The discern, infer, and decide module 66 may be part of an intent phase. Also, the act module 68 may be part of a control phase for making physical and/or virtual changes or modifications to the compute, connect, and store module 62.

In the present disclosure, one issue of concern may be the efficient allocation of service requests within the fabric in order to handle (act upon) as many service requests as possible, thus maximizing fabric utilization. The self-optimizing framework 60 may be configured to solve or at least improve upon the resource allocation issue. Thus, by maximizing (or improving) utilization, revenue that may be received by a service provider can also be maximized, as it allows for the maximum number of service requests to be handled before fabric saturation. A service request, for example, may be defined as a collection of inter-connected Virtual Network Functions (VNFs), each parameterized by its physical resources (e.g., processing device 42, memory device 44, database 50, etc.) and by communication resources (e.g., links 14) that may be defined according to bandwidth, latency, and/or jitter characteristics.

It may be noted that the framework of sensing and taking optimal actions is a foundational aspect of reinforcement learning (RL), which may have the goal of achieving and/or maintaining an “optimal state” by maximizing its long-term cumulative rewards received from the underlying environment.

FIG. 5 is a block diagram illustrating an embodiment of an RL feedback loop 70. The RL feedback loop 70 includes an environment 72 and an agent 74. The environment 72 may represent any node and/or at least part of the distributed system 10, or other system or environment. The agent 74 may represent the agent 12 described with respect to FIG. 1. It may be noted that the RL feedback loop 70 may bear some similarities with the self-optimizing framework 60 and/or an SDIDA framework. The RL feedback loop 70 may be an RL action-reward feedback loop, where the agent 74 receives reward information from the environment 72 and creates an action to continue increasing the reward as much as possible. In the service request scenario, a high reward may include a greater network resource utilization and thereby a higher revenue stream being received.

In RL, an objective is to determine a “best” policy or at least the best possible achievable policy. A function may map the state (Sₜ) of the environment 72 to an action (Aₜ). In some embodiments, this RL goal may translate to finding the most optimal assignment with respect to future service requests and states within the fabric given a particular state of the underlying fabric.

The present disclosure describes the algorithms and methods which may manifest a collective intelligence via distributed RL agents. Each agent can make independent decisions, while collectively, they achieve a desired global goal, which may include efficiently allocating as many service requests as possible within the fabric to achieve maximum fabric utilization. Referring again to FIG. 1, it should be understood that the coordinator 16 is not a central controller as used in conventional systems where the central controller has visibility of the entire system or network and attempts to optimize on this large scale. Instead, the coordinator 16 in the present disclosure merely coordinates the scheduling of self-optimization on a local level at each agent. Thus, with localized RL processing, the systems may be considered to be decentralized. Therefore, instead of relying on a single controller to sense the full environment (e.g., system, network, etc.) and make complex decisions, as defined in conventional system, the embodiments of the present disclosure are configured to decouple the decision making to each agent and jointly implementing the best action for a service request.

Some of the driving motivations for the present disclosure include a) scalability, b) adaptability, and c) security. Regarding “scalability,” as a network continues to expand and change, a centralized agent would normally need to encode a growing high-dimensional state space (or observation space), along with increasing service request demand. However, by distributing the intelligence as defined in the present disclosure, the state space remains relatively constant per agent. It may to noted that decentralization may remove the requirements for expensive GPUs and can therefore bring down hardware costs. Also, it may be feasible to train in parallel on multiple CPU cores.

Regarding “adaptability,” a centralized controller of the conventional systems may be trained for a specific topology and service request and data flow. However, over time, the network may change via additions, failures, and modifications of nodes/links. Thus, the central controller would need to re-train an already complex policy. In the distributed embodiments of the present disclosure, only the agents affected immediately by local changes would need to update their less-complex policies.

Regarding “security,” there is no longer a need to store all the information in a single centralized database which may be vulnerable to a single point of attack. Furthermore, each distributed agent has a summary of information with respect to its local neighborhood. This opaqueness would not allow for a faithful reconstruction of the entire network topology and resource information in the case where a bad actor had full access to a subset of nodes.

### Parallelized Agent Training

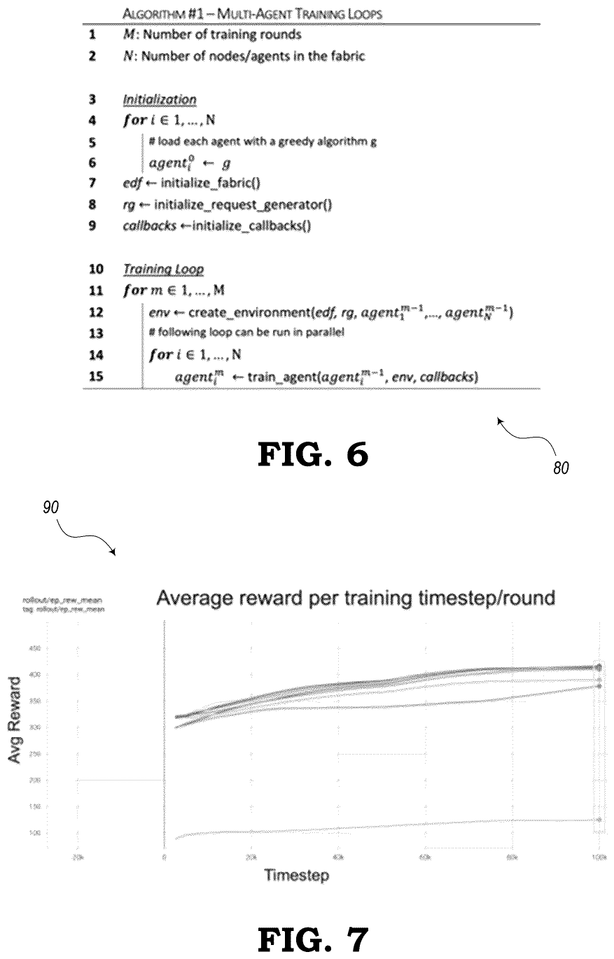

Reference is made again to FIG. 1. It may be noted that there are agents 12 that are not connected by links 14 to certain other agents 12 or they are otherwise separated to such a degree where there is little affiliation between them. In this case, these pairs of agents 12 can be trained in parallel. Regarding this parallelized agent training, each node in the network may be trained with an RL agent over successive rounds. In order to train a model-free Deep-RL agent, an emulator may be used. The emulator may be configured to contain data regarding a representation of the test environment. The environment in this case may include the network topology (along with its resources) and information about the service requests. The service request information can come in the form of a dataset, from which samples may be fed into an offline training module. Alternatively, a generative model can be created which represents the expected flow of requests. One training algorithm is presented in FIG. 6.

FIG. 6 is a diagram illustrating an embodiment of an algorithm 80 for performing a multi-agent training loop. From an individual agent perspective, one agent performs a training step while the other agents are frozen. Thus, the training agent works with a fixed (or stationary) environment during each round and trains on this fixed portion of the network. The training agent also works with the other nearby agents (or those having a relatively high level of some type of affiliation with the training agent). Thus, the training agent includes relevant data. Note, agents do not share policies with each other. Rather, the state of the environment as described by resources as well as rewards are shared. Rewards are shared since the result of an allocation may be a few hops away from the training agent where the initial request came in. These localized RL policies are continuously updated until convergence can be reached. That is, training may continue until the reward for any particular agent is maximized (or improved up to a certain degree or percentage).

FIG. 7 is a graph 90 illustrating an example of a training scenario where an average reward per training round during an RL training process is shown. The graph 90 shows rewards for a given training timestep for different rounds. The graph 90 represents a test scenario and shows how the reward improves over time during each round, timestep, or time interval. It may be noted that at some point, the reward value reaches a point of diminishing returns. That is, further optimization does not lead to a significant increase in reward. Therefore, the agents 12 themselves and/or the coordinator 16 may be configured to discontinue the training round or the entire training process.

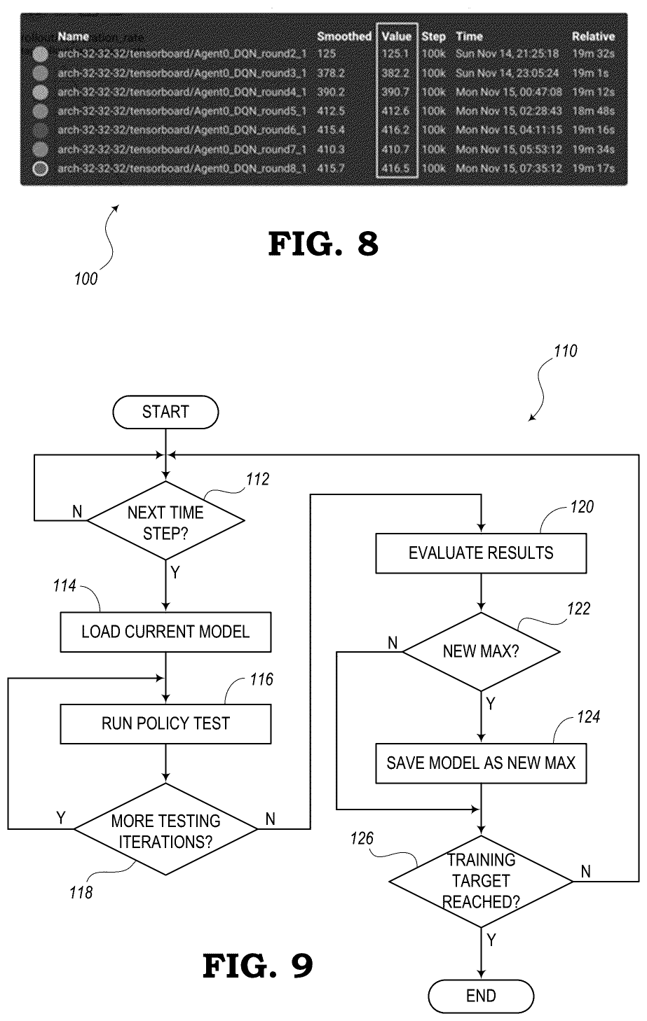

FIG. 8 is a table 100 illustrating an example of reward values resulting at the end of each round of training and provides the final reward after each round. The training may be continued as long as the reward increases over successive rounds, eventually reaching a maximum.

### Callbacks

FIG. 9 is a flow diagram illustrating an embodiment of a process 110 having a sequence of callbacks initiated during every round of a training process. The process 110 includes determining if a next time interval is due, as indicated in decision diamond 112. If not, the process 110 waits until the next time interval. At this point, the process 110 includes loading a current model, as indicated in block 114. The process 110 also includes running a policy test, as indicated in block 116. The, the process 110 determines if more testing iterations are needed, as indicated in decision diamond 118. If so, the process 110 goes back to block 116 to run more test. If not, the process 110 proceeds to block 120.

The process 110 further includes the step of evaluating the results, as indicated in block 120. Then, the process 110 determines if a new max is attained, as indicated in decision diamond 122. If so, the process 110 saves the model as the new max, as indicated in block 124. Otherwise, block 124 is skipped and the process 110 goes to decision diamond 126, which includes determining if a training target is reached. If not, the process 110 jumps back to the top and waits for the next time interval. If the training target is reached, the process 110 ends.

The callbacks may be a useful technique for calling a function at set interval times during an agent training. The callbacks provide useful interim results which can induce modifications to parameters such as learning rate or exploration factor. Additionally, the agents 12 (and/or coordinator 16) may use the results from the callbacks to decide whether to stop training. By default, an agent will train with as many timesteps specified. However, some embodiments may include stopping the training early depending on some conditions. Since the model performance is not necessarily monotonic with respect to the training time (i.e., it does not necessary increase at all points in time), the process 110 can leverage callbacks to keep track of the best model obtained thus far.

For example, it may be possible to leverage callbacks related to performance evaluation. At each interval T, the process 110 can load the current agent into the fabric, run multiple episodes, and calculate the total revenue and number of requests fulfilled. If the evaluation results in a new maximum, the model can save it as a new best. If the evaluation reaches a pre-define target, the process 110 can stop training.

A callback, in some respects, may be defined as a function that is called at a set time interval. Depending on aspects of the function, the process 110 may decide what to do next. In some embodiments, the callbacks may define that, after a certain number of training steps, an evaluation is done, and a score is calculated. If that score is better than the previous one, the system can save the best model. Also, the system can stop training and move on to the next node.

### Reward Functions

In addition to callbacks, the agents 12 may be configured to utilize various reward functions. For example, one goal of the present disclosure is to maximize the global utility (resource utilization) which derives from maximizing the local utility of each individual agent. Thus, the reward incentivizes each agent 12 to either fulfill a portion of the service request itself and/or forward the remaining portion of the service request to one or more neighbors which might result in a successful allocation. The agents 12 may be configured so as not to compete with each other since the system does not differentiate between a request coming in externally or via a neighboring node.

In its simplest form, the reward function may return “+1” for a successful allocation and “−1” for a failed allocation. This may allow for the greatest degree of freedom for the agents 12 in terms of decision making, as it allows the agents 12 to learn to maximize request fulfillment in the fabric over time. Such a function would maximize the request acceptance rate. Alternatively, the distributed system 10 may want to maximize for revenue, which is a function of the number of resources asked by the request as described in the following equation:

R=α₁N_{C}+α₂N_{M}+α₃N_{S}+α₄N_{BW}+α₅N_{L}

where as are coefficients, N_{C} is the number of compute resources, N_{M} is the number of memory resources, N_{S} is the number of store resources, New is the number of bandwidth resources, and N_{L} is the number of latency resources. The equation is a weighted reward function to maximize revenue. The reward assigned to each service request is a weighted sum proportional to the number of resources assigned (e.g., compute, memory, store, bandwidth, latency, etc.).

In this case, the reward function may consider the number of resources asked by the service request, resulting in scaled rewards. This has the benefit of deterring a policy from learning to reject big requests to fulfill several smaller requests. In general, revenue may be more representative of operational efficiency versus pure acceptance rate.

Since the agent 12 receives a reward for each successful allocation, it will learn to efficiently assign resources in such a way to maximize the cumulative rewards. Thus, the agents 12 will learn effective long term planning and anticipate future request types as learned by its environment. In other words, allocations are made to maximize the probability of success of future requests.

### State and Action Encoding

In general, the environment state consists of an encoding of the observed information from an agent's perspective. In the context of a training environment, SOF, etc., the observed information may include network resource information (compute and store), link information (bandwidth, latency, jitter), and the immediate service request which seeks to be allocated onto the fabric. This state is then used as an input to the policy function π:S→A which provides an action related to service request allocation.

In a single agent architecture of the conventional systems, the state is an encoding of the entire observable network along with the service request. The action would then comprise a service plan, described by a set of nodes, and links onto which the request could be allocated. As noted before, this leads to a very high-dimensional state/action space requiring longer training time to reach convergence as well as larger compute/memory requirements.

In the distributed scenario of the present disclosure, each node comprises an independent agent. Its observation space encodes information about itself, immediate links, and information received from neighbors along with the service request for that node. The actions may fall into two main categories: self-allocation applied to the next head-of-line VNF and/or forwarding the remaining portions of the request to a neighboring node for allocation.

In some embodiments, state encoding may comprise normalizing the state features between 0 and 1. This may allow for greater training stability for neural nets. Without normalization, scale imbalances may cause some features to have a disproportionate influence on the output.

### Training and Inference Models

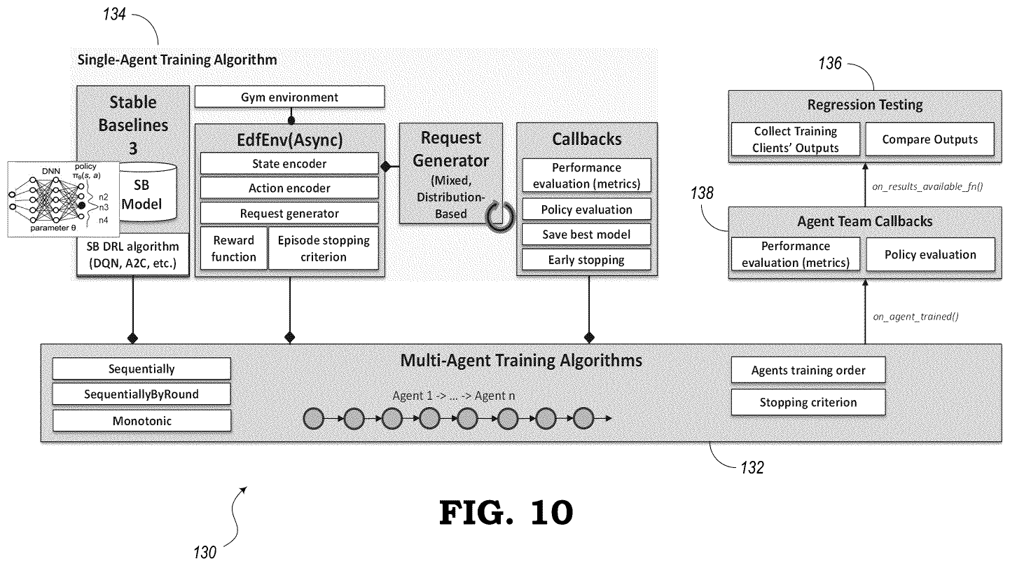

FIG. 10 is a block diagram illustrating a system 130 for training multiple agents in a distributed system, according to various embodiments. The system 130 includes a group of multi-agent training algorithms 132 and multiple single-agent training algorithms 134, one of which is shown in FIG. 10. The system 130 also include regression testing 136 and agent team callback 138.

The multi-agent training algorithms 132 may include data with respect to ordering the agents in a predetermined sequence, monotonic variables for defining increasing reward computations, training stoppage characteristics, etc. The single-agent training algorithm 134 includes stable baselines (e.g., stable baselines 3, but note we could use any RL training framework; stable baselines is just one example), Deep Neural Network (DNN) algorithms, stable baseline database, a gym or testing environment, a model (e.g., simulated, emulated, etc.) of an environment, including state encoders, action encoders, request generators, reward function algorithms, round stoppage criteria, request generator, and callback algorithms that include performance evaluation (metrics), policy evaluation, save best model, and early stopping.

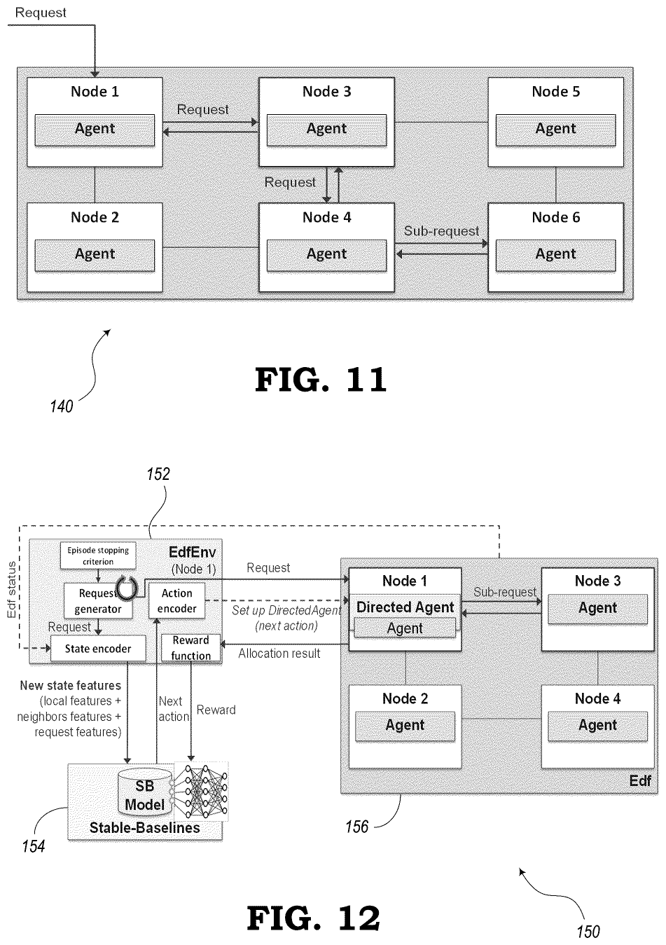

FIG. 11 is a block diagram illustrating an environment 140 (e.g., network) for handling a service request received in the environment 140. The environment 140 in this example includes six nodes (e.g., Nodes 1-6), where each node includes an RL agent. For example, a unique RL policy may be embedded in the RL agent of each node. The RL agents are configured for receiving the service requests, and based on the how the unique RL policy is trained for the respective node, the respective RL agents are configured to allocate network resources in the environment 140 accordingly. In this example, Node 1 receives the original request. Node 1 may be configured to act on at least a portion of the request or may be configured to pass the request without acting. The remaining portions of the request (or the whole request) are forwarded to Node 3 in this example, which again may act on any portion as instructed by the RL policy of that node. This continues to Node 4 and finally to Node 6. Each node's agent decides what to do with the request (or sub-request) according to its unique RL policy determined during the training phase.

FIG. 12 is a block diagram illustrating an embodiment of a system 150 for training a stable-baseline model in a distributed system. In one example, tests were performed on real or simulated environments related to the Evolution of Networked Services through a Corridor in Quebec and Ontario for Research and Innovation (ENCQOR), which is a Canadian research and innovation collaboration for developing communications networks. The system 150 includes a training environment 152, which includes episode stoppage criteria, request generator, state encoder, action encoder, and reward function. The system 150 also includes stable baselines 154 and a network 156 having multiple nodes. Each node in the network includes an agent for acting upon a service request.

The training environment 152 is configured to generate requests that target a learning node (e.g., Node 1 of the network 156). The training environment 152 is configured to train RL models for head-of-line VNFs of the requests. The state encoder of the training environment 152 is configured to encode the request plus a fabric status as features. The action encoder of the training environment 152 is configured to convert an output of a model of the stable-baselines 154, whereby the output may typically be an integer, into an actual node object to allocate/forward the request to the network 156. The system 150 may be configured whereby the state space (or observation space) is consistent between the state encoder of the training environment 152 and the model of the stable baselines 154. Also, an action space is configured to be consistent between the action encoder of the training environment 152 and the model of the stable baselines 154.

### Results

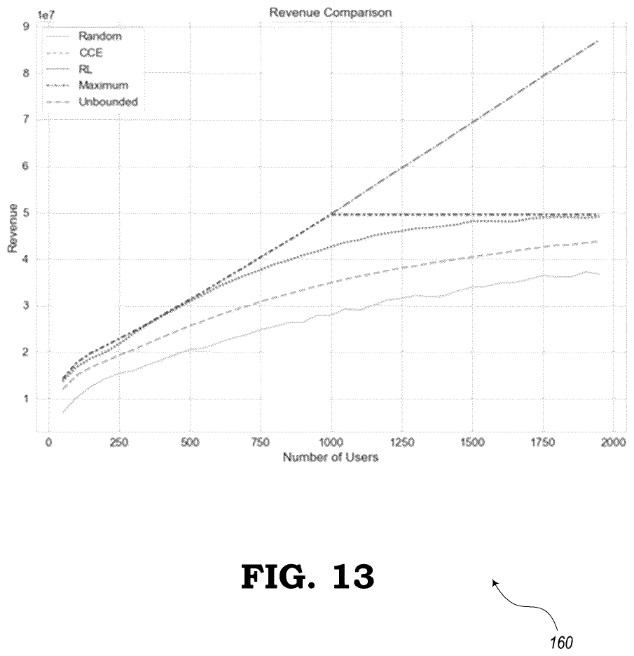

FIG. 13 is a graph 160 illustrating test results demonstrating the capabilities of the RL models and policies of the present disclosure compared to conventional models. In the example results, the graph 160 shows a comparison of revenue obtained for different algorithms for varying traffics loads (tuned via the number of users requesting services). A conventional CCE algorithm is based on a load balancing approach, such that requests are sent to areas of the network with the lowest utilization. A maximum line signifies an upper bound calculated by the revenue if all requests were accepted into the fabric. The distributed RL agents, which represent results of the systems and methods of the present disclosure, are shown to outperform the CCE algorithm for all traffic loads. Also the distributed RL agents of the present disclosure are even able to reach the maximum revenue value for certain loads (i.e., 300-600 users).

### Agent-Based and Coordinator-Based Training and Inference Processes

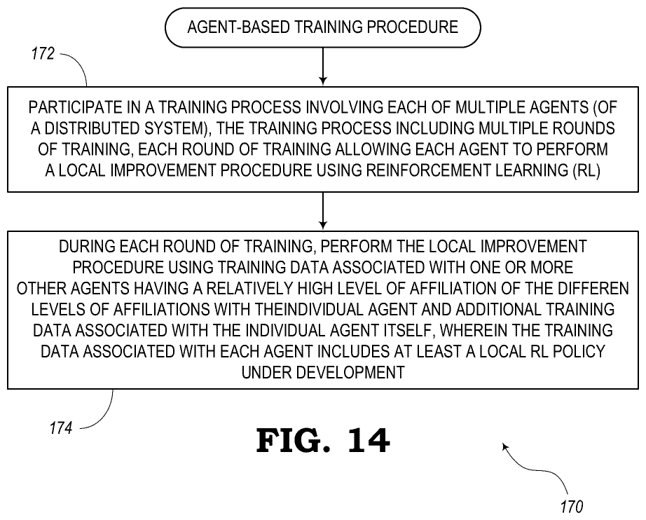

FIG. 14 is a flow diagram illustrating an embodiment of a process 170 for training an individual agent of a distributed system and may be referred to as an agent-based training process. The process 170 may be implemented in a non-transitory computer-readable medium associated with an individual agent arranged within the distributed system. The distributed system may have multiple agents and multiple links, wherein the agents and links are arranged in such a way so as to create different levels of affiliations between the agents. The process 170 may include participating in a training process involving each of the multiple agents, as indicated in block 172. The training process may include multiple rounds of training, where each round of training allows each agent to perform a local improvement procedure using Reinforcement Learning (RL). During each round of training, the process 170 further includes performing the local improvement procedure (for the individual agent) using training data associated with one or more other agents having a relatively high level of affiliation of the different levels of affiliations with the individual agent and additional training data associated with the individual agent itself, as indicated in block 174. The training data associated with each agent may include at least a local RL policy under development.

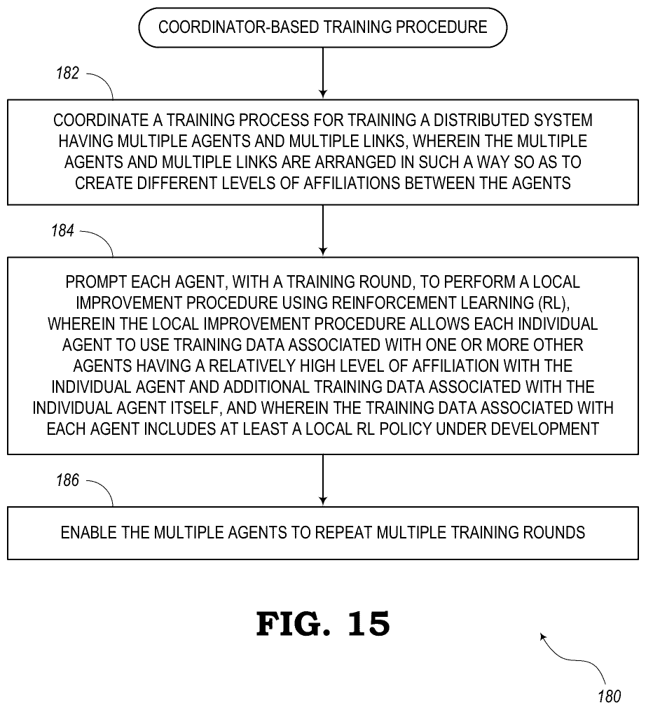

FIG. 15 is a flow diagram illustrating an embodiment of a process 180 for coordinating a training procedure for a distributed system and may be referred to as a coordinator-based training process. The process 180 may be implemented in a non-transitory computer-readable medium associated with a coordinator (e.g., coordinator 16) arranged within or in communication with the distributed system. The process 180 includes coordinating a training process for training a distributed system having multiple agents and multiple links, as indicated in block 182. The multiple agents and multiple links are arranged in such a way so as to create different levels of affiliations between the agents. The process 180 also includes prompting each agent, within a training round, to perform a local improvement procedure using Reinforcement Learning (RL), as indicated in block 184. The local improvement procedure allows each individual agent to use training data associated with one or more other agents having a relatively high level of affiliation of the different levels of affiliations with the individual agent and additional training data associated with the individual agent itself. Also, the training data associated with each agent includes at least a local RL policy under development. Also, the process 180 includes enabling the multiple agents to repeat multiple training rounds, as indicated in block 186.

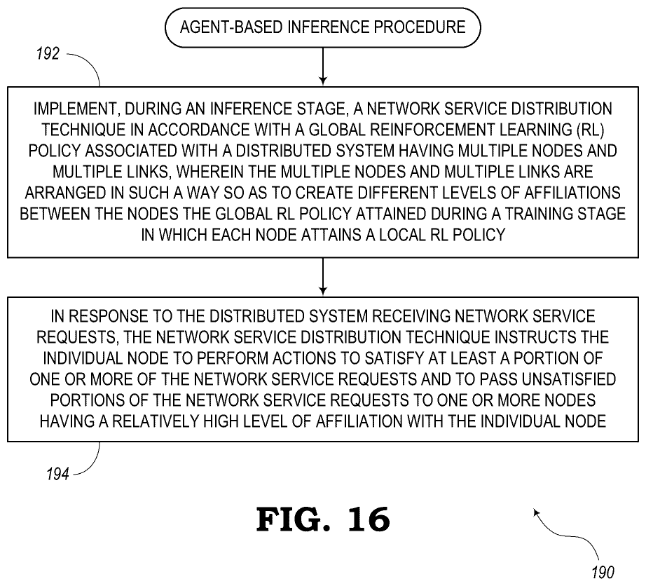

FIG. 16 is a flow diagram illustrating an embodiment of a process 190 for implementing a global RL policy and may be referred to as an agent-based inference process. The process 190 may be implemented in a non-transitory computer-readable medium associated with an individual agent arranged within a distributed system. The distributed system may have multiple nodes and multiple links, wherein the nodes and links are arranged in such a way so as to create different levels of affiliations between the nodes. During an inference stage, the process 190 includes implementing a network service distribution technique in accordance with a global Reinforcement Learning (RL) policy associated with the distributed system, as indicated in block 192. The global RL policy may be attained during a training stage in which each node attains a local RL policy. In response to the distributed system receiving network service requests, the network service distribution technique of the process 190 includes instructing the individual node to perform actions to satisfy at least a portion of one or more of the network service requests and to pass unsatisfied portions of the network service requests to one or more nodes having a relatively high level of affiliation of the different levels of affiliations with the individual node, as indicated in block 194.

### Additional Implementation Details

According to various embodiments of the present disclosure, a distributed and decentralized fabric is utilized, whereby each node has an agent that participates in a self-optimizing function. The RL policies may be configured to efficiently allocate service requests within the fabric in order to handle as many as possible, thereby maximizing fabric utilization. Each agent can make independent self-optimization decisions. Also, collectively, a global goal is to efficiently allocate as many service requests as possible within the fabric to achieve maximum fabric utilization.

Also, SOF can maintain optimal states by continuously updating its model with respect to the changing environment. This include adjusting the latest RL policy for itself (each node) based on demands, modifications, and events for its own allocation and allocations to neighboring nodes. In RL, a state value and reward value from the environment, which are provided to an agent. The agent processes and analyzes the state and reward values to determine an action that is applied (or fed back) to the environment. This can be repeated multiple times.

In some cases, the network service requests may be implemented as a collection of inter-connected Virtual Network Functions (VNFs). The VNFs may be parameterized by their compute, memory, store, bandwidth, and latency requirements. Also, the RL may attempt to maintain an optimal state by maximizing its long-term cumulative rewards. This may include finding the most optimal assignments of a service request within the fabric given a particular state of the underlying fabric.

The scheduling of training (e.g., by the coordinator 16) may include using a sequence where each agent is configured to optimize on its own localized environment. Then a second round of training for each agent is repeated, and this can continue for multiple rounds. In some embodiments, the agent sequence may be a predetermined order determined by the coordinator 16. In other embodiments, the sequence may be random. In still other embodiments, the sequence may include an order determined by the nodes themselves based on certain priorities. In still other embodiments, the sequence may include maximizing the distance (or number of hops) from one node to the next, which may include certain benefits, such as allowing parallel training and allowing remote nodes to establish certain resource allocations from outside positions and working in. In still other embodiments, each round of training may include a different sequence or order in which the agents perform the self-optimization.

In some embodiments, an emulator may be used to represent the environment. The environment may include a network (with its resources and topology) and information about the service requests. The state space (or observation space) of each agent may include the respective node on which the agent is running plus the neighboring nodes and links connected to the respective node.

Each agent may be initialized with a rules-based algorithm. The algorithm may be based on assigning resources to the parts of the network with the least amount of utilization. This may provide a respectable benchmark such that a learning agent would still most likely receive a positive reward for making a correct forwarding decision, since the environment (compromising of other agents) would make reasonable decisions downstream. If an agent starts with random policies, the feedback from the environment might be noisy and may become more difficult to learn from.

According to various embodiments, each agent is configured to work independently. The sequence may include allow one agent at a time to perform the self-optimization, while the other wait. With a single agent being trained, all policies of the other agents are frozen. Hence, the environment is stationary for that current round of training.

From an agent's perspective, its environment is slightly different between two different rounds. Hence, the environment is non-stationary, since each agent has its policy updated from the previous round. Also, for each new round of training, all hyper-parameters (e.g., learning rate, exploration factor, etc.) may be reset. Also, a replay buffer at each round may be reset so as not to mix samples from the previous round. With the learning rate reset, the RL algorithm has a chance to get out of a local maxima with respect to the agents return.

In order to minimize the difference in environment dynamics between rounds, callbacks may be used to stop training as soon as the evaluation over the entire agent team is better or once a target number of steps is reached. Hence, the system can minimize the drift between rounds in order to mimic a type of continuous learning. Furthermore, the embodiments of the present disclosure may include message passing techniques such that each agent would advertise information about the resources it has.

Training may be performed on a digital twin (e.g., full emulation of the network topology which serves as the environment). During training, the coordinator 16 may be used to determine when to start/stop learning on a particular node. The coordinator 16 may also be responsible for deploying new policies. It may be noted that the coordinator 16 differs from conventional Multi-Agent Reinforcement Learning (MARL) systems, which may include centralized values or critic functions. The coordinator 16 may be used for storing global metrics for comparison. However, once trained, execution is fully decentralized without the need for the coordinator 16 or other type of centralized control device.

The present disclosure is configured to provide a solution for efficiently allocating (or assigning) service requests to available resources. Knowledge of the multiple agents and their available resources are used for resource allocation. Each node can make a decision independently about what to do with a request or a part of the request. Then it can pass it along to one of their edges to a neighboring node to allow that node to decide what to do with the remaining part of the request.

Each node has a set of resources that can be available for handling requests. For example, each node might have available CPU, memory, storage, etc. Also, the links connecting the nodes can be evaluated to determine communication properties available. That is, the links also include certain properties, such as latency, bandwidth, jitter, etc. Suppose, according to one example, that a service request (e.g., a service function change) is received in a network that has three nodes. Also, suppose three VNFs or services are needed back-to-back, such as a firewall, a filter, and a content provider. To satisfy these three back-to-back VNFs, the system can determine, via the local RL improvement/optimization functions, that all those VNFs cannot be handled on a single node, since perhaps no single node has all these capabilities or resources. Therefore, the agent may determine that it can handle one service and pass the other two to one or more other nodes that may be known to be able to handle these services or portions of the services. The nodes are therefore configured to cooperate with each their neighboring nodes to work out the allocation issues, since trying to handle too much or not enough results in an efficient allocation scheme and resources may run out to easily.

Since it may not be apparent how requests should be allocated during a first round of training, it may be noted that each round is designed to make small incremental improvement in the allocation RL scheme. After several rounds, the allocation strategy may reach a much improved plan, even close to an optimized plan. Each node makes the best decision based on what it knows and lets the other nodes fill in some added information. The next round may be the same and may distribute allocations to more resources, and so on.

Each round of the training process may include training each agent, one at a time, while the others are frozen or fixed. The reason why the others are fixed is that if they were also learning at the same time, then the environment might be changing while training, resulting in a non-stationary system, where the agent is making actions and is getting feedback, but then the environment is changing as it goes along. Therefore, in some embodiments, it may be best to train one at a time to optimize towards a fixed environment. Then, in the next round, training can be directed to a slightly adjusted environment.

As each agent is learning and getting a better or improved policy, the process may utilize callbacks, as described above, which basically prevent any one agent or node from being overtrained. Thus, the system attempts to train just enough that it's a bit better. And then the system can go on to the next one. In the next iteration, the environment is full of the next best (slightly better) policy, and this is repeated. Part of the RL process may include determine how far each training session can go before it is time to go on to the next one. If an agent makes too large of a change, then the agent might over-fit to the current environment, which is expected to change anyway.

After the training process and a local RL policy is determined for each agent, the agents can be configured in a real-world environment to run on new raw data. Re-training may be performed during use to further develop the RL policies and optimize the global rewards. Also, as the environment changes (e.g., when one or more nodes or links are added to or removed from a network), re-training may be performed using a combination of new data and relevant historical data. Once the RL policies are deployed, the nodes may run smoothly, allocating requests to different resources on different nodes and links. Nevertheless, an additional part of the implementation of the RL policies (or inference) may include message passing functionality to build the local state from the global state.

The resource allocation techniques described in the present disclosure may be applied to a distributed system and may also be applied to a data center. For example, the RL policies may be configured to optimize resource allocations with respect to data traffic in the data center, to forward traffic from a set of ingress to egress points while avoiding congestion.

In some situations, it may be understood that parallel training may cause issues if two nearby agents attempt to change the environment at the same time. Thus, creating a schedule where each agent has a limited amount of time and a limited amount of sway or influence causing some type of change to the environment, each agent performs a local improvement procedure (e.g., self-optimization) independently while other agents remain frozen, each agent get one chance to perform the local improvement procedure during each round of training, and the training process may include multiples training rounds.

Otherwise, an issue that may arise is that each agent's policy might be changing as training progresses, and the environment becomes non-stationary from the perspective of any individual agent in a way that is not explainable by changes in the agent's own policy. This could present learning stability challenges and prevent the straightforward use of past experience replay, which may be important in some cases for stabilizing deep Q-learning.

The systems and methods of the present disclosure may be configured to overcome these challenges, for example, as follows:
1. Each agent may be initialized with a rule-based algorithm. In some cases, the algorithm may be based on assigning resources to parts of the network with the least amount of utilization. This provided a respectable benchmark such that a learning agent would likely receive a positive reward for making a correct forwarding decision, since the environment (including other agents) would make reasonable decisions “downstream” (or later in the order in which the agents are individually trained). For instance, if the agents started with random policies, the feedback from the environment would likely be extremely noisy and nearly impossible to learn from.
2. While a single agent is being trained, all policies of the other agents are frozen. Hence, the environment is stationary for that current round of training.
3. From an agent's perspective, its environment is slightly different between two different rounds (hence the non-stationarity) since each agent has its policy updated from the previous round. However, the local improvement procedures described herein may reset all hyper-parameters (e.g., learning rate, exploration factor, etc.) in a replay buffer at each round as to not to mix samples from the previous round. With the learning rate reset, the RL algorithm has a chance to get out of a local maxima.
4. In order to minimize the difference in environment dynamics between rounds, the training procedure may use callbacks to stop training as soon as the evaluation over the entire agent team is better, or once a target number of steps is reached. Hence, the training procedure can minimize the drift between rounds in order to mimic a type of continuous learning.

Each individual agent performing the local optimization, again, does not have access to the global state. Instead, the “fabric” or entire group of agents/nodes can use a message-passing technique such that each agent would advertise information about the resources it has. In order to reduce the number of messages, the system may use mutually exclusive bucket ranges for latency and resource types. For example, given a particular node and interface, its resource table for its CPU may look like the following:

| | 0-2 cores | 2-6 cores | 6+ cores |
|---|---|---|---|
| 0-100 ms | 1 | 0 | 0 |
| 100-1000 ms | 0 | 1 | 1 |
| 1000+ ms | 0 | 1 | 0 |

where 0 represents absence and 1 represents existence/presence.

This is a summarized view of the CPU from an agent's perspective for a particular interface such that it is given the existence (i.e., 1) of a particular resource range within a latency range. Therefore, each agent has an aggregate view of all the network resources down a particular interface. The number of messages transmitted in the network depends on the granularity of the ranges.

The distinction between the training and inference stages should be emphasized herein. For example, during training, a central controller (e.g., coordinator 16) may be used in various embodiments, although training may be performed without any type of central controller in the embodiments involve message-passing techniques among the agents and processing that mimics the functionality of the coordinator 16 as described herein. Training may be done on a digital “twin” (e.g., full emulation of the network topology which serves as the environment). During training, the central controller or coordinator (or functionality within the agents themselves) may be configured to determine when to start/stop learning for each particular agent/node and may take on the responsibility of deploying or sharing new RL policies under development. On the other hand, during inference, there is no centralized control, functionality, coordination, etc. It should be noted that the omission of any centralized control, functionality, and coordination during inference in the embodiments of the present disclosure are a distinct difference from conventional MARL algorithms and provide noticeable and beneficial differences. For example, the embodiments of the present disclosure are able to quickly and efficiently handle service requests in a decentralized manner without the need for control or coordination from a remote system.

The systems and methods of the present disclosure may use “rules-based” algorithms that collectively have global resource visibility. For example, the rules-based algorithms can rely on summarized information instead of full global resource visibility. Hence, the present embodiments may use an estimate based on the granularity of the resource/latency bucket ranges.

The present systems may have global heart-beat control for sequentially resolving resource request conflicts and for RL training of agents one at a time. While a single agent is being trained, all policies of the other agents may be frozen. Extended visibility of reward functions, which may not be local but may extend over more than a one-hop range, may be configured to stop training as soon as the evaluation over the entire agent team is better. That is, rewards are propagated back to the learning node if a service request was successfully allocated. This is via the same mechanism that the network uses to commit resources if a solution was found (e.g., when the service path is stored in a stack which gets passed between nodes during the search).

In one example, for a given node in a network, the state space size may stay constant when using local state encodings, whereas with a global state, the size would normally increase exponentially with the number of nodes. This may depend on the quantization used (e.g., number of bucket ranges per resource). This number may be treated as a hyper-parameter in the training phase. Consider, for example, a network with v nodes with average degrees d. For simplicity, suppose a single resource r is encoded with q quantization levels (e.g., where a 0 or 1 value is used to represent whether or not a resource exists). For local state encodings with message passing, on average, the state space size will be 2^{q*d}. However, for the global state, the state space size will be 2^{q*v}, which will be significantly higher, especially as a network scales.

It should also be noted that if a global state were to be used, as is normally done in conventional systems, the input vector size into the neural net would change if the network topology was modified even slightly. Therefore, conventional systems would need to retrain a large model with the new input, which can be very expensive for large networks. With distributed RL, as described herein, a small change in the network (e.g., addition of a new node) would only impact the state space size of the agents directly connected to this change. Re-training a significantly smaller neural network would of course be much more feasible.

### CONCLUSION

It will be appreciated that some embodiments described herein may include or utilize one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field-Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured to,” “logic configured to,” etc. perform a set of operations, steps, methods, processes, algorithms, functions, techniques, etc. on digital and/or analog signals as described herein for the various embodiments.

Moreover, some embodiments may include a non-transitory computer-readable medium having instructions stored thereon for programming a computer, server, appliance, device, at least one processor, circuit/circuitry, etc. to perform functions as described and claimed herein. Examples of such non-transitory computer-readable medium include, but are not limited to, a hard disk, an optical storage device, a magnetic storage device, a Read-Only Memory (ROM), a Programmable ROM (PROM), an Erasable PROM (EPROM), an Electrically EPROM (EEPROM), Flash memory, and the like. When stored in the non-transitory computer-readable medium, software can include instructions executable by one or more processors (e.g., any type of programmable circuitry or logic) that, in response to such execution, cause the one or more processors to perform a set of operations, steps, methods, processes, algorithms, functions, techniques, etc. as described herein for the various embodiments.

Although the present disclosure has been illustrated and described herein with reference to various embodiments and examples, it will be readily apparent to those of ordinary skill in the art that other embodiments and examples may perform similar functions, achieve like results, and/or provide other advantages. Modifications, additions, or omissions may be made to the systems, apparatuses, and methods described herein without departing from the spirit and scope of the present disclosure. All equivalent or alternative embodiments that fall within the spirit and scope of the present disclosure are contemplated thereby and are intended to be covered by the following claims.

What is claimed is:

1. A non-transitory computer-readable medium associated with an individual agent arranged within a distributed system having multiple agents and multiple links, wherein the multiple agents and multiple links are arranged in such a way so as to create different levels of affiliations between the agents, the non-transitory computer-readable medium configured to store computer logic having instructions that, when executed, enable one or more processing devices to:
participate in a training process involving each of the multiple agents, the training process including multiple rounds of training, each round of training allowing each agent to perform a local improvement procedure using Reinforcement Learning (RL); and
during each round of training, perform the local improvement procedure using training data associated with one or more other agents having a relatively high level of affiliation of the different levels of affiliations with the individual agent and additional training data associated with the individual agent itself, wherein the training data associated with each agent includes at least a local RL policy under development.

2. The non-transitory computer-readable medium of claim 1, wherein the individual agent has little or no visibility of another set of one or more other agents having a relatively low level of affiliation of the different levels of affiliation with the individual agent.

3. The non-transitory computer-readable medium of claim 1, wherein the local improvement procedure is configured to increase an RL reward of the local RL policy under development.

4. The non-transitory computer-readable medium of claim 3, wherein, in each round, the local improvement procedure is configured to increase the RL reward of the local RL policy under development up to a certain degree.

5. The non-transitory computer-readable medium of claim 1, wherein, after each round of training is complete, the local RL policy is provided for a global reward calculation related to an optimization of the entire distributed system.

6. The non-transitory computer-readable medium of claim 1, wherein, in each round, the associated agent performs its local improvement procedure at a predetermined sequence.

7. The non-transitory computer-readable medium of claim 1, wherein the distributed system is one of a real-world system, a virtual system, and a simulated system.

8. The non-transitory computer-readable medium of claim 1, wherein the distributed system is a communications network, each agent of the multiple agents is associated with a network node, the individual agent is associated with an individual network node, and each link is associated with a communication path between nodes.

9. The non-transitory computer-readable medium of claim 8, wherein the training data and the additional training data includes resource availability information of respective agent related to an ability to perform network service functions.

10. The non-transitory computer-readable medium of claim 8, wherein the local RL policy under development is combined with the local RL policies of the other agents such that a global RL policy emerges for maximizing utilization of the network nodes to handle as many network service requests as possible.

11. The non-transitory computer-readable medium of claim 10, wherein, after completing the multiple rounds of training of the training process, each network node is configured to utilize a network service distribution technique, to perform actions intended to meet one or more network service requests or one or more portions of network service requests and to pass one or more network service requests or one or more portions of network service request to one or more adjacent network nodes, wherein each of the one or more adjacent network nodes is represented by an agent having a relatively high level of affiliation of the different levels of affiliation with the individual agent associated with the individual network node.

12. A non-transitory computer-readable medium configured to store computer logic having instructions that, when executed, enable one or more processing devices to:
coordinate a training process for training a distributed system having multiple agents and multiple links, wherein the multiple agents and multiple links are arranged in such a way so as to create different levels of affiliations between the agents;
prompt each agent, within a training round, to perform a local improvement procedure using Reinforcement Learning (RL), wherein the local improvement procedure allows each individual agent to use training data associated with one or more other agents having a relatively high level of affiliation of the different levels of affiliation with the individual agent and additional training data associated with the individual agent itself, and wherein the training data associated with each agent includes at least a local RL policy under development; and
enable the multiple agents to repeat multiple training rounds.

13. The non-transitory computer-readable medium of claim 12, wherein each of one or more agents has little or no visibility of a set of other agents having a relatively low level of affiliation of the different levels of affiliation with the respective agent.

14. The non-transitory computer-readable medium of claim 12, wherein the local improvement procedure is configured to increase an RL reward of the local RL policy under development.

15. The non-transitory computer-readable medium of claim 14, wherein the instructions further enable the one or more processing devices to allow each agent, in each training round, to increase the RL reward of the local RL policy under development up to a certain degree.

16. The non-transitory computer-readable medium of claim 12, wherein, after each training round, aa global reward value is achieved related to an optimization of the entire distributed system.

17. The non-transitory computer-readable medium of claim 12, wherein the instructions further enable the one or more processing devices to coordinate the agents such that, within each training round, each agent, one at a time, is allowed to perform its respective local improvement procedure in accordance with a predetermined sequence.

18. The non-transitory computer-readable medium of claim 12, wherein the distributed system is one of a real-world system, a virtual system, and a simulated system.

19. The non-transitory computer-readable medium of claim 12, wherein the distributed system is a communications network, each agent is associated with a network node, and each link is associated with a communication path between nodes.

20. The non-transitory computer-readable medium of claim 19, wherein the training data associated with each agent includes resource availability information related to an ability to perform network service functions.
